(19) United States
(12) Patent Application Publication
(10) Pub. No.: US 2023/0162720 A1
(43) Pub. Date: May 25, 2023

(54) GENERATION AND DELIVERY OF TEXT-BASED CONTENT USING ARTIFICIAL INTELLIGENCE (AI) BASED TECHNIQUES

(71) Applicant: Meta Platforms, Inc., Menlo Park, CA (US)

(72) Inventor: Sammy EL GHAZZAL, Oberengstringen (CH)

(73) Assignee: Meta Platforms, Inc., Menlo Park, CA (US)

(21) Appl. No.: 17/456,124

(22) Filed: Nov. 22, 2021

(51) Int. Cl. G10L 13/08; G10L 15/04; G10L 15/06

(52) U.S. Cl. CPC G10L 13/08; G10L 15/04; G10L 15/063; G10L 2015/0631

(57) ABSTRACT

According to examples, a system for using artificial intelligence (AI) techniques to generate audio and video content based on text content is described. The system may include a processor and a memory storing instructions. The processor, when executing the instructions, may cause the system to analyze a plurality of text segments associated with a text content item having text content, determine an association between the plurality of text segments and arrange the plurality of text segments based on the determined association, wherein the arranging includes generating one or more text segment clusters. The processor, when executing the instructions, may then order the one or more text segment clusters according to one or more ordering criteria, implement a wording algorithm to generate text for a content item to be generated based on the text content and generate an audio association for the text for the content item to be generated.

### TECHNICAL FIELD

This patent application relates generally to generation and delivery of content, and more specifically, to systems and methods for using artificial intelligence (AI) techniques to generate audio and video content based on text content.

### BACKGROUND

With recent advances in technology, prevalence and proliferation of content creation and delivery has increased greatly in recent years. Content creators are continuously looking for ways to deliver more appealing content.

One of the most appealing and convenient forms of content is audio content. Examples include audio stream casts and podcasts. Listeners may particularly favor audio content as it may enable them to passively consume the content (i.e., via listening) while focusing on other tasks as well.

Another form of content consumed by users is text content. Examples include electronic question & answer (Q&A) sessions and ask-me-anything (AMA) sessions. Readers may read responses to one or more questions submitted by one or more users and pertaining to any subject matter. However, it should be appreciated that, in some instances, consuming text content may be inconvenient for a reader, as it may require more effort and may require the reader to remain in front of a display device.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a diagram of an implementation structure for a neural network (NN) implementing deep learning to generate audio and video content based on text content, according to an example.

FIGS. 2A-B illustrates a block diagram of a system environment, including a system, that may be implemented to use artificial intelligence (AI) techniques to generate audio and video content based on text content, according to an example.

FIG. 3 illustrates a block diagram of a computer system to use artificial intelligence (AI) techniques to generate audio and video content based on text content, according to an example.

FIG. 4 illustrate a method for using artificial intelligence (AI) techniques to generate audio and video content based on text content, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Advances in content management and media distribution are causing users to engage with content on or from a variety of content platforms. As used herein, a “user” may include any user of a computing device or digital content delivery mechanism who receives or interacts with delivered content items, which may be visual, non-visual, or a combination thereof. Also, as used herein, “content”, “digital content”, “digital content item” and “content item” may refer to any digital data (e.g., a data file). Examples include, but are not limited to, digital images, digital video files, digital audio files, and/or streaming content. Additionally, the terms “content”, “digital content item,” “content item,” and “digital item” may refer interchangeably to themselves or to portions thereof.

With the proliferation of different types of digital content delivery mechanisms (e.g., mobile phone, portable computing devices, tablet devices, etc.), it has become crucial that content providers engage users with content of interest and deliver the content in the most convenient manner possible. As a result, content providers are continuously looking for ways to efficiently deliver more appealing content.

One of the most appealing and convenient forms of content is audio content. Examples include podcasts and audio stream casts. Audience members particularly favor audio content as it may be consumed while “on the move”. For example, audio content may be consumed via a speaker on a user device (e.g., a mobile phone) or by listening devices (e.g., a headphone), while maintaining a user's mobility. Another advantage may be that audio content may enable them to passively consume (i.e., via listening) the content, often while focusing on other tasks as well.

Another form of content consumed by users is text content. Examples include electronic question & answer (Q&A) and ask-me-anything (AMA) sessions. Typically, a user (i.e., reader) may seek out a question & answer (Q&A) session or an ask-me-anything session taking place with a person or a subject matter of interest. In these instances, the person of interest may respond to one or more questions. However, in some instances, consuming text content may in some instances, be inconvenient for the user as it may require more effort and may require the user to remain in front of a display device.

Systems and methods described may provide for generation of audio and video content based on text content using artificial intelligence (AI) techniques. As used herein, “text content” may include any content item including text. Examples of text content may include electronic question and answer (Q&A) sessions and ask-me-anything (AMA) sessions.

In some examples, text content may include one or more text segments. Moreover, as used herein, “a text segment” may include a portion of text from text content. Examples of a text segment include a question, an answer to a question, a question and an associated answer and a paragraph of text. So, in an example where a text content may be an ask-me-anything session between a plurality of participants (e.g., a single questioner and a plurality of responders or a single questioner and a single responder), and the systems and methods may utilize a plurality of questions and associated answers (i.e., text segments) to generate an audio podcast (i.e., content item) for an audience member.

In some examples, to generate audio and video content, the systems and methods may analyze various aspects of a text segment. In particular, in some examples, the systems and methods may analyze the text segment to generate an embedding. Also, in some examples, the systems and methods may generate the embedding to map words or phrases from the text segment to a vector constituting real numbers, and wherein the embedding may provide a conversational representation of the text segment.

In some examples, the systems and methods may utilize an embedding to determine one or more associations between a plurality of text segments and to “cluster” (i.e., associate and/or arrange) the plurality of text segments. In some examples, the systems and methods may cluster the plurality of text segments based on various associations and/or criteria. For example, in some instances, the systems and methods may group the plurality of text segments according to subject matter to generate a cluster of text segments (or “text segment clusters”), wherein text segments with similar subject matter may be arranged closer together.

In some examples, the systems and methods may determine an ordering for a plurality of text segment clusters according to various criteria. As discussed further below, examples may include quantitative criteria, qualitative criteria, and chronology. Additional aspects that may be considered may include aspects associated with an audience member or a participant.

In some examples, the systems and methods may generate text for a content item based on an ordering of text segment clusters. So, in some examples, a series of words associated with a text segment (e.g., a question and associated answer) may be associated with corresponding text. In particular, the “pairs” of text segment(s) and corresponding text may be used to generate text for a content item to be generated.

Furthermore, in some examples, the systems and methods may provide an audio association for an audio or video content item. In particular, in some examples, the systems and methods may provide an audio association based on a (generated) text for a content item, wherein the audio association may be an audio (e.g., spoken word) version of the text for use with the content item (e.g., a podcast).

The systems and methods described herein may be implemented in various contexts. In some examples, the systems and methods may enable generation of audio or video content items based on text content items. In some examples, the systems and methods may utilize artificial intelligence (AI) based techniques to analyze a text segment of a text content item, generate text for a content item based on the text segment, and generate an audio association for the text for the content item. Examples may include an audio podcast, wherein an audience member may listen to the audio podcast that may represent a spoken word, “conversational” version.

Accordingly, content creators may utilize the systems and methods described to efficiently generate content items that may be (more) conveniently consumed by audience members. It should be appreciated that while the examples described herein may relate primarily to content generation, the systems and methods described may have numerous other applications as well.

In some examples and as described herein, a neural network (NN) that may be implemented may include one or more computing devices configured to implement one or more networked machine-learning (ML) algorithms to “learn” by progressively extracting higher-level information from input data. In some examples, the one or more networked machine-learning (ML) algorithms of a neural network (NN) may implement “deep learning”. A neural network (NN) implementing deep learning and artificial intelligence (AI) techniques may, in some examples, utilize one or more “layers” to dynamically transform input data into progressively more abstract and/or composite representations. These abstract and/or composite representations may be analyzed to determine hidden patterns and correlations and determine one or more relationships or association(s) within the input data. In addition, the one or more determined relationships or associations may be utilized to make predictions, such a likelihood that a user will be interested in a content item.

The systems and methods described herein may utilize various neural network (NN) technologies. Examples of neural network (NN) mechanisms that may be employed may include an artificial neural network (ANN), a sparse neural network (SNN), a convolutional neural network (CNN), and a recurrent neural network (RNN). Additional examples of neural network mechanisms that may be employed may also include a long/short term memory (LSTM), a gated repeated unit (GRU), a Hopfield network, a Boltzmann machine, a deep belief network and a generative adversarial network (GAN).

In addition to content item analysis and recommendation, neural networks (NN) may have a number of other applications as well. Exemplary applications may include text, image, audio and video recognition, natural language processing and machine learning. Additional examples may include recommendation systems, audio recognition (e.g., for virtual assistants), autonomous driving, social networks and bioinformatics.

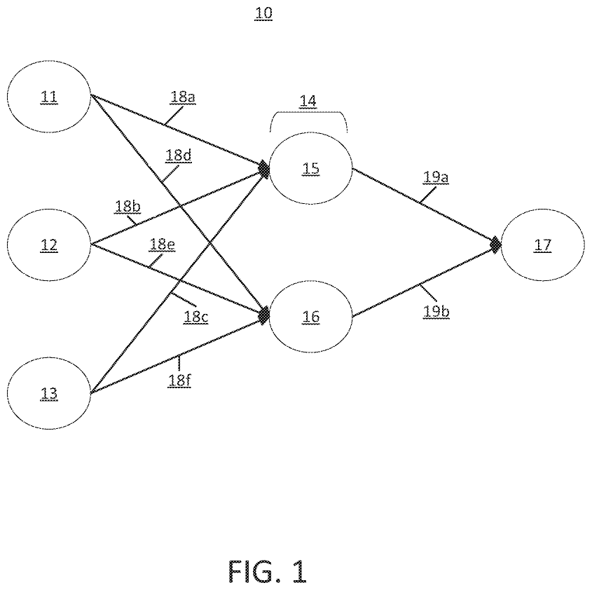

FIG. 1 illustrates a diagram of an implementation structure for a neural network (NN) implementing deep learning to generate audio and video content based on text content. In some examples, implementation of neural network 10 (hereinafter also referred to as “network 10”) may include organizing a structure of the network 10 and “training” the network 10.

In some examples, organizing the structure of the network 10 may include network elements including one or more inputs, one or more nodes and an output. In some examples, a structure of the network 10 may be defined to include a plurality of inputs 11, 12, 13, a layer 14 with a plurality of nodes 15, 16, and an output 17. In addition, in some examples, organizing the structure of the network 10 may include assigning one or more weights associated with the plurality of nodes 15, 16. In some examples, the network 10 may implement a first group of weights 18, including a first weight 18a between the input 11 and the node 15, a second weight 18b between the input 12 and the node 15, a third weight 18c between the input 13 and the node 15. In addition, the network 10 may implement a fourth weight 18d between the input 11 and the node 16, a fifth weight 18e between the input 12 and the node 16, and a sixth weight 18f between the input 13 and the node 16 as well. In addition, a second group of weights 19, including the first weight 19a between the node 15 and the output 17 and the second weight 19b between the node 16 and the output 17 may be implemented as well.

In some examples, “training” the network 10 may include utilization of one or more “training datasets” {(xᵢ, yᵢ)}, where i=1 N for an N number of data pairs. In particular, as will be discussed below, the one or more training datasets {(xᵢ, yᵢ)} may be used to adjust weight values associated with the network 10.

Training of the network 10 may also include, in some examples, may also include implementation of forward propagation and backpropagation. Implementation of forward propagation and backpropagation may include enabling the network 10 to adjust aspects, such as weight values associated with nodes, by looking to past iterations and outputs. In some examples, a forward “sweep” through the network 10 to compute an output for each layer. At this point, in some examples, a difference (i.e., a “loss”) between an output of a final layer and a desired output may be “back-propagated” through previous layers by adjusting weight values associated with the nodes in order to minimize a difference between an estimated output from the network 10 (i.e., an “estimated output”) and an output the network 10 was meant to produce (i.e., a “ground truth”). In some examples, training of the network 10 may require numerous iterations, as the weights may be continually adjusted to minimize a difference between estimated output and an output the network 10 was meant to produce.

In some examples, once weights for the network 10 may be learned, the network 10 may be used make an “inference” and/or determine a prediction loss. In some examples, the network 10 may make an inference for a data instance, which may not have been included in the training datasets {(xᵢ, yᵢ)}, to provide an output value y* (i.e., an inference) associated with the data instance x*. Furthermore, in some examples, a prediction loss indicating a predictive quality (i.e., accuracy) of the network 10 may be ascertained by determining a “loss” representing a difference between the estimated output value y* and an associated ground truth value.

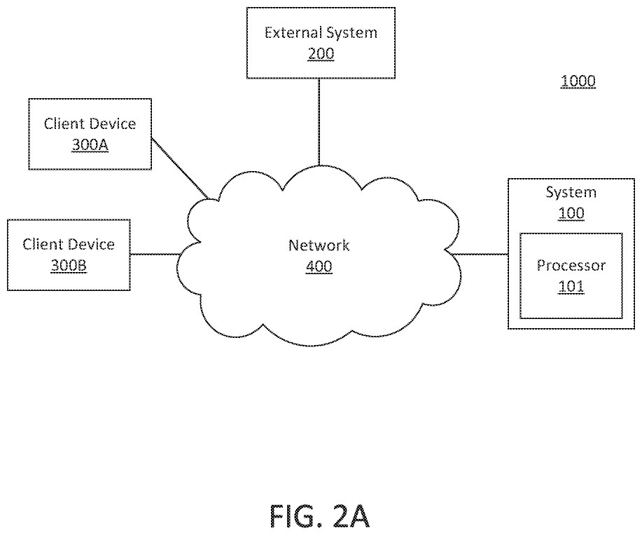

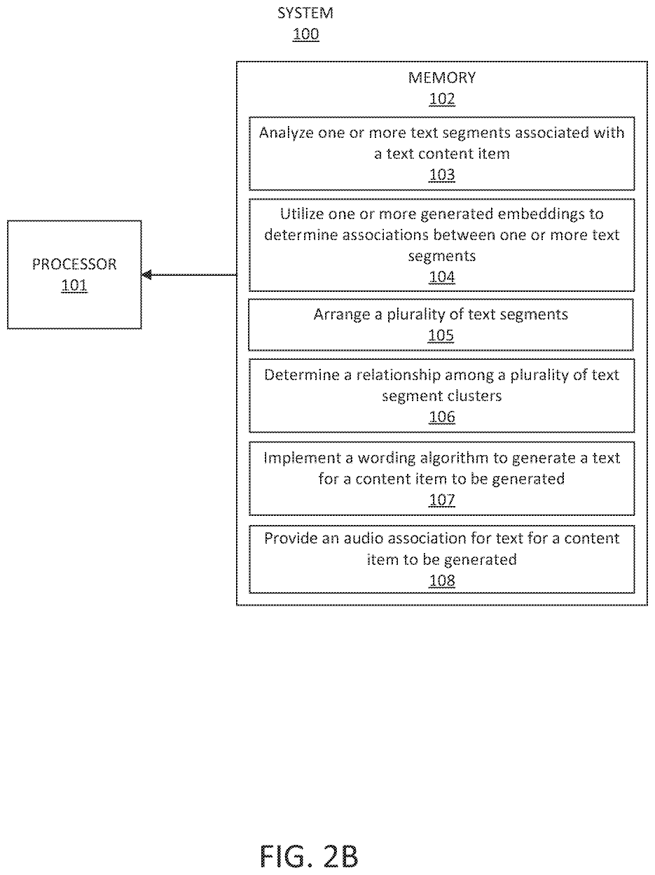

Reference is now made to FIGS. 2A-B. FIG. 2A illustrates a block diagram of a system environment, including a system, that may be implemented to utilize artificial intelligence (AI) techniques to generate audio and video content based on text content, according to an example. FIG. 2B illustrates a block diagram of the system that may be implemented to utilize artificial intelligence (AI) techniques to generate audio and video content based on text content, according to an example.

As will be described in the examples below, one or more of system 100, external system 200, user devices 300A-B and system environment 1000 shown in FIGS. 2A-B may be operated by a service provider to utilize artificial intelligence (AI) techniques to generate audio and video content based on text content. It should be appreciated that one or more of the system 100, the external system 200, the user devices 300A-B and the system environment 1000 depicted in FIGS. 2A-B may be provided as examples. Thus, one or more of the system 100, the external system 200 the user devices 300A-B and the system environment 1000 may or may not include additional features and some of the features described herein may be removed and/or modified without departing from the scopes of the system 100, the external system 200, the user devices 300A-B and the system environment 1000 outlined herein. Moreover, in some examples, the system 100, the external system 200, and/or the user devices 300A-B may be or associated with a social networking system, a content sharing network, an advertisement system, an online system, and/or any other system that facilitates any variety of digital content in personal, social, commercial, financial, and/or enterprise environments.

While the servers, systems, subsystems, and/or other computing devices shown in FIGS. 2A-B may be shown as single components or elements, it should be appreciated that one of ordinary skill in the art would recognize that these single components or elements may represent multiple components or elements, and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the system 100, the external system 200, the user devices 300A-B or the system environment 1000.

It should also be appreciated that the systems and methods described herein may be particularly suited for digital content, but are also applicable to a host of other distributed content or media. These may include, for example, content or media associated with data management platforms, search or recommendation engines, social media, and/or data communications involving communication of potentially personal, private, or sensitive data or information. These and other benefits will be apparent in the descriptions provided herein.

In some examples, the external system 200 may include any number of servers, hosts, systems, and/or databases that store data to be accessed by the system 100, the user devices 300A-B, and/or other network elements (not shown) in the system environment 1000. In addition, in some examples, the servers, hosts, systems, and/or databases of the external system 200 may include one or more storage mediums storing any data. In some examples, and as will be discussed further below, the external system 200 may be utilized to store any information that may relate to generation and delivery of content (e.g., user information, etc.). As will be discussed further below, in other examples, the external system 200 may be utilized by a service provider (e.g., a social media application provider) as part of a data storage, wherein a service provider may access data on the external system 200 to generate audio and video content based on text content.

In some examples, and as will be described in further detail below, the user devices 300A-B may be utilized to, among other things, utilize artificial intelligence (AI) techniques to generate audio and video content based on text content. In some examples, the user devices 300A-B may be electronic or computing devices configured to transmit and/or receive data. In this regard, each of the user devices 300A-B may be any device having computer functionality, such as a television, a radio, a smartphone, a tablet, a laptop, a watch, a desktop, a server, or other computing or entertainment device or appliance. In some examples, the user devices 300A-B may be mobile devices that are communicatively coupled to the network 400 and enabled to interact with various network elements over the network 400. In some examples, the user devices 300A-B may execute an application allowing a user of the user devices 300A-B to interact with various network elements on the network 400. Additionally, the user devices 300A-B may execute a browser or application to enable interaction between the user devices 300A-B and the system 100 via the network 400.

Moreover, in some examples and as will also be discussed further below, the user devices 300A-B may be utilized by a user viewing content (e.g., advertisements) distributed by a service provider, wherein information relating to the user may be stored and transmitted by the user devices 300A to other devices, such as the external system 200. In some examples, and as will described further below, a user may utilize the user device 300A to provide recommendation information (e.g., a “like”). Also, in some examples, the recommendation information is provided by a user utilized the user device 300A may be utilized to generate a dialogue text associated with an audio or video content item that may be accessed and consumed (i.e., listened to) by a user utilizing the user device 300B.

The system environment 1000 may also include the network 400. In operation, one or more of the system 100, the external system 200 and the user devices 300A-B may communicate with one or more of the other devices via the network 400. The network 400 may be a local area network (LAN), a wide area network (WAN), the Internet, a cellular network, a cable network, a satellite network, or other network that facilitates communication between, the system 100, the external system 200, the user devices 300A-B and/or any other system, component, or device connected to the network 400. The network 400 may further include one, or any number, of the exemplary types of networks mentioned above operating as a stand-alone network or in cooperation with each other. For example, the network 400 may utilize one or more protocols of one or more clients or servers to which they are communicatively coupled. The network 400 may facilitate transmission of data according to a transmission protocol of any of the devices and/or systems in the network 400. Although the network 400 is depicted as a single network in the system environment 1000 of FIG. 2A, it should be appreciated that, in some examples, the network 400 may include a plurality of interconnected networks as well.

In some examples, and as will be discussed further below, the system 100 may be configured to utilize artificial intelligence (AI) techniques to generate audio and video content based on text content. Details of the system 100 and its operation within the system environment 1000 will be described in more detail below.

As shown in FIGS. 2A-B, the system 100 may include processor 101, a graphics processor unit (GPU) 101a, and the memory 102. In some examples, the processor 101 may be configured to execute the machine-readable instructions stored in the memory 102. It should be appreciated that the processor 101 may be a semiconductor-based microprocessor, a central processing unit (CPU), an application specific integrated circuit (ASIC), a field-programmable gate array (FPGA), and/or other suitable hardware device.

In some examples, the memory 102 may have stored thereon machine-readable instructions (which may also be termed computer-readable instructions) that the processor 101 may execute. The memory 102 may be an electronic, magnetic, optical, or other physical storage device that contains or stores executable instructions. The memory 102 may be, for example, random access memory (RAM), an Electrically Erasable Programmable Read-Only Memory (EEPROM), a storage device, an optical disc, or the like. The memory 102, which may also be referred to as a computer-readable storage medium, may be a non-transitory machine-readable storage medium, where the term “non-transitory” does not encompass transitory propagating signals. It should be appreciated that the memory 102 depicted in FIGS. 2A-B may be provided as an example. Thus, the memory 102 may or may not include additional features, and some of the features described herein may be removed and/or modified without departing from the scope of the memory 102 outlined herein.

It should be appreciated that, and as described further below, the processing performed via the instructions on the memory 102 may or may not be performed, in part or in total, with the aid of other information and data, such as information and data provided by the external system 200 and/or the user devices 300A-B. Moreover, and as described further below, it should be appreciated that the processing performed via the instructions on the memory 102 may or may not be performed, in part or in total, with the aid of or in addition to processing provided by other devices, including for example, the external system 200 and/or the user devices 300A-B.

In some examples, the memory 102 may store instructions, which when executed by the processor 101, may cause the processor to: analyze 103 one or more text segments associated with a text content item; utilize 104 one or more embeddings to determine associations between one or more text segments; arrange 105 a plurality of text segments; determine 106 an relationship among a plurality of text segment clusters; implement 107 a wording algorithm to generate text for a content item to be generated; and provide 108 an audio association.

In some examples, and as discussed further below, the instructions 103-108 on the memory 102 may be executed alone or in combination by the processor 101 to utilize artificial intelligence (AI) techniques to generate audio and video content based on text content. In some examples, the instructions 103-108 may be implemented in association with a content platform configured to provide content for users, while in other examples, the instructions 103-108 may be implemented as part of a stand-alone application.

Additionally, and as described above, although not depicted, it should be appreciated that to provide generation and delivery of content, instructions 103-108 may be configured to utilize various artificial intelligence (AI) and machine learning (ML) based tools. For instance, these artificial intelligence (AI) and machine learning (ML) based tools may be used to generate models that may include a neural network (e.g., a recurrent neural network (RNN)), generative adversarial network (GAN), a tree-based model, a Bayesian network, a support vector, clustering, a kernel method, a spline, a knowledge graph, or an ensemble of one or more of these and other techniques. It should also be appreciated that the system 100 may provide other types of machine learning (ML) approaches, such as reinforcement learning, feature learning, anomaly detection, etc.

In some examples, the instructions 103 may analyze one or more text segments associated with a text content item. So, in some examples, the text content item may be a text transcript of a question & answer (Q&A) session, and the text segment may be a question and an associated answer from the question & answer (Q&A) session.

In these examples, the instructions 103 may analyze text associated with a text segment (e.g., a question and an associated answer) to generate an embedding. In some examples, the embedding may represent a “topic” associated with the text segment. In some examples and as discussed further below, the embedding may be utilized to generate a conversational representation of the text segment. It should be appreciated that for a text content item, the instructions 103 may generate one or more embeddings associated with one or more text segments.

In some examples, the instructions 103 may generate various types of embeddings. For example, in some instances, the embeddings may be dense or sparse. That is, the embeddings generated via the instructions 103 may be dense in that it may analyze text associated with a text segment based on a greater number of (e.g., one hundred) aspects. In these instances, each of the aspects may be associated with a dimension of the embedding, wherein the instructions 103 may analyze (i.e., focus on) the text and the associated answer along each of these dimensions. Also, the embeddings generated via the instructions 103 may be sparse in that it may analyze text associated with a text segment based on a lesser number of aspects (e.g., three aspects including subject matter, presence of celebrities, and text length).

Furthermore, in some examples, the instructions 103 may generate an embedding according to a variety of associated aspects. In a first example, the instructions 103 may generate an embedding having a dimension associated with content of a text segment. In a second example, the instructions 103 may generate an embedding having a dimension associated with a user that may have originated the text segment. In a third example, the instructions 103 may generate an embedding having a dimension associated with a user that may have responded to the text segment. Furthermore, in a fourth example, the instructions 103 may generate an embedding having a dimension based on a determination of where the text segment may fall in a sequence of associated text segments (e.g., a sequence of questions in an ask-me-anything (AMA) session). And in a fifth example, the instructions 103 may associate a dimension of an embedding with a determined (i.e., predicted) interest level of a particular audience member. In yet another example, the instructions 103 may account for engagement metrics (e.g., a number of “likes” or shares) in an embedding as well.

In some examples, the instructions 103 may generate an embedding via use of a vector representation. That is, in some examples, the instructions 103 may model (i.e., analyze) the embedding to determine where words or phrases present in a text segment that may be mapped to a vector constituting real numbers. Moreover, in some examples, the instructions 103 may generate the embedding to represent one or more words such that words that are closer together in an associated vector space may be expected to be similar in subject matter and/or meaning.

It should be appreciated that to generate an embedding, the instructions 103 may utilize one or more neural networking techniques and/or probabilistic methods. In some examples, a neural network (NN) (e.g., Word2Vec) may be utilized to determine one or more word associations present in a text segment. For example, once the neural network (NN) may be trained, it may be utilized to generate equivalent phrasings, detect synonymous words or suggest additional words for a partial sentence.

In some examples, the instructions 104 may utilize one or more embeddings to determine associations between one or more text segments. So, in an example where a text content item may be a question & answer (Q&A) session having a plurality of questions and answers, and a text segment may be a question and an associated answer from the questions & answer (Q&A) session, the instructions 104 may determine associations between a plurality of questions and associated answers based on various criteria.

In some examples, the instructions 104 may determine associations between a plurality of text segments based on content (i.e., subject matter). Also, in some examples, the instructions 104 may identify and analyze key words associated with the text segments to determine a topic associated with each text segment. In other examples, the instructions 104 may determine an association by identifying synonyms for words found in each text segment. And in still other examples, the instructions 104 may determine an association by identifying a redundancy. In these examples, the instructions 104 may also determine a degree of redundancy and may further generate a text summary that may reduce redundant subject matter.

In some examples, the instructions 104 may determine a relationship between a plurality of text segments. As used herein, a “relationship” may be evidenced by a connection or dependency between a first text segment and a second text segment. So, in some examples, the instructions 104 may determine a second “follow-up” text segment may be related to a first “originating” text segment. It should be appreciated that a first text segment may be related to a second text segment regardless of an ordering associated with the first text segment and the second text segment. That is, in one example including ten questions, the originating question may be the third question of the ten questions, while the follow-up question may be the ninth question of the ten. Also, in some examples, the instructions 104 may determine a relationship between the plurality of text segments by analyzing browsing or engagement patterns between text segments. So, for example, if one or more users may return to review a first (e.g., previous) text segment after reading a second text segment, the instructions 104 may determine that the first text segment and the second text segment may be related. In other examples, the instructions 104 may utilize engagement metrics from one or more users to determine relationships between the plurality of text segments. So, in some of these examples, the instructions 104 may determine a degree a similarity between users (e.g., based on profile information and/or browsing histories), and may utilize a sufficient degree of similarity to determine engagement (e.g., a number of “likes”, stars or shares) with a first text segment and a second text segment by similar users may indicate a relationship between the first text segment and the second text segment.

In some examples, the instructions 105 may arrange a plurality of text segments. In some examples, the instructions 105 may arrange the plurality of text segments based on various criteria and/or one or more associations determined for the plurality of text segments. Also, in some examples, the instructions 105 may utilize one or more embeddings associated with the plurality of text segments to arrange the plurality of text segments.

In some examples, the instructions 105 may arrange a first embedding associated with a first text segment to be “closer” to a second embedding associated with a second text segment. In some examples, the instructions 105 may “cluster” a plurality of text segments based on various criteria and/or associations. As such, the instructions 105 may cluster a first text segment with one or more other text segments in a group of text segments. Furthermore, in some examples, the instructions 105 may also arrange the text segments wherein a part of a first text segment (e.g., a question and its associated answer) may be combined with a part of a second text segment. It should be appreciated that to generate one or more text segment clusters, various algorithms may be utilized by the instructions 105 to arrange the one or more text segments, such as K-means clustering, hierarchical clustering or CURE (clustering using representatives).

In some examples, the instructions 106 may determine a relationship between a plurality of text segment clusters. In some examples, the relationship may be represented by an ordering. In some examples, the ordering of the plurality of text segments clusters may be determined by various ordering criteria. In some examples, the ordering determined by the instructions 106 may be based on quantitative criteria, wherein one or more metrics may be utilized to order a plurality of text segment clusters. Examples of the metrics may include “likes”, replies/responses or comments. So, in one example, questions with a greater number of likes may be ordered before questions with a lesser number of likes. In other examples, the ordering implemented by the instructions 106 may be based on qualitative criteria. In some examples, to implement an example of an ordering based on qualitative criteria, the instructions 106 may generate an ordering to provide a particular experience to an audience member. In particular, in some examples, the ordering may be implemented to provide a “natural” and/or “conversational” quality. For example, in one such instance, the ordering may be implemented wherein each subject matter may be addressed in sequence with greater detail. It should be appreciated that to implement qualitative criteria to determine an ordering of text segment clusters, the instructions 106 may utilize various artificial intelligence (AI) and machine learning (ML) based tools. Furthermore, in some examples, the ordering implemented by the instructions 106 may be based on a chronological criterion. In one example, a first, earlier cluster of questions may be ordered before a second, later cluster of questions.

In some examples, to generate an ordering of a plurality of text segment clusters, the instructions 106 may implement an ordering score. For example, the ordering score may be assigned to each text segment cluster, wherein the ordering score may be used to determine an ordering for the plurality of text segment clusters.

Moreover, in some examples, the instructions 106 may utilize aspects associated with an audience member to implement an ordering of a plurality of text segment clusters. In particular, in some examples, the instructions 106 may determine the ordering of the plurality of text segment clusters based on interests and/or preferences of an audience member, wherein the interests and/or preferences may be utilized to filter one or more text segment clusters and/or to prioritize particular text segment clusters over others.

Furthermore, the instructions 106 may utilize a recommendation algorithm to order a plurality of text segment clusters. In particular, in some examples, the instructions 106 may implement the recommendation algorithm to generate and/or provide preference information for an audience member. In these examples, the recommendation algorithm implemented by the instructions 106 may analyze (among other things) associated metrics, user behavior(s), and historical patterns of a user and may generate preference information that may be used to order the plurality of text segment clusters. In addition, in some examples, the instructions 106 may incorporate preference information for other users (e.g., similarly situated audience members) as well.

So, in a first example involving a question & answer (Q&A) session with an executive of a company where an audience member works as an engineer, the instructions 106 may arrange text segment clusters pertaining to a new product launch prior to other topics. In a second example involving (a transcript of) a corporate governance seminar, the instructions 106 may arrange text segment clusters pertaining to human resources (HR) topics for a human resources (HR) employee. Also, in a third example involving a question & answer (Q&A) session with a well-known sports commentator, the instructions 106 may arrange text segment clusters associated with professional football prior to others for an audience member that may have an interest in professional football.

In some examples, the instructions 107 may implement a wording algorithm to generate text for a content item to be generated. As used herein, a “wording algorithm” may include any implementation of any algorithm, including via use of neural networks (NN), artificial intelligence (AI) or machine learning (ML), that may be used to generate text that may be used for generation of a content item. So, in one example, the instructions 107 may utilize and/or implement a recurrent neural network (RNN) to associate text of a text segment from an ordered cluster of text segments to (corresponding) text for a content item to be generated. Examples of content items to be generated may include audio content (e.g., a podcast) and a video content (e.g., a video with text commentary).

In some examples, a wording algorithm may be used to generate an embedding for each text segment (i.e., a series of words associated with the text segment) among an ordered cluster of text segments. So, in some examples, where each text segment may be represented in vector format, the wording algorithm may utilize a vector associated with each text segment to transform the text of the text segment into text for a content item to be generated. In particular, in some examples, a series of words of a text segment may be associated with corresponding (e.g., conversational) text, wherein the series of words of the text segment and the corresponding text may constitute a “pair”. In some examples, and a neural network (e.g., a recurrent neural network (RNN)) may utilize these “pairs” to generate the text for the content item to be generated.

Furthermore, in some examples, the instructions 107 may implement a wording algorithm to paraphrase text associated with an ordered cluster of text segments. For example, the instructions 107 may implement the wording algorithm to avoid repetitions. So, in some examples, the avoiding of repetitions may be implemented as part of a summarization feature of the wording algorithm. Moreover, in some examples, the summarization feature of the wording algorithm may also be implemented to generate a content item of a first length (e.g., five minutes) for a first audience member, and a content item of a second length (e.g., twenty minutes) for a second audience member.

In some examples, the instructions 107 may implement an interest score associated with a user. In some examples, each text segment of a plurality of text segments may be analyzed to ascribe an interest score, wherein if an interest score associated with a text segment may be below a threshold, the text segment may be discarded (i.e., not included) from text of a content item to be generated.

In some examples, upon determining text for a content item to be generated, the instructions 108 may provide an audio association. As used herein, an “audio association” may include any audio rendition of the text for the content item to be generated. In particular, in some examples, the instructions 108 may provide a “vocalization” of the text for the content item to be generated.

In some examples, the instructions 108 may generate an audio association according to a preferred vocalization. In particular, in some examples, the instructions 108 may enable an audience member to indicate a preference associated with a vocalization. In a first example, the instructions 108 may enable an audience member to associate a voice of another (preferred) party, such as a celebrity or politician. In a second example, the instructions 108 may enable an audience member to associate their own voice. In this example, the instructions 108 may enable a user to provide (spoken) audio associated with one or more predetermined phrases, and the instructions 108 may utilize the provided audio to generate the audio association. In some instances, where an audience member may not have provided a preference, the instructions 108 may utilize a generic voice to generate the audio association as well.

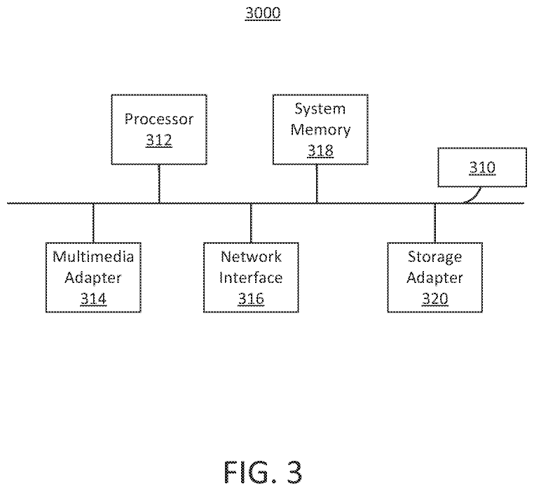

FIG. 3 illustrates a block diagram of a computer system to use artificial intelligence (AI) techniques to generate audio and video content based on text content, according to an example. In some examples, the system 3000 may be associated the system 100 to perform the functions and features described herein. The system 3000 may include, among other things, an interconnect 310, a processor 312, a multimedia adapter 314, a network interface 316, a system memory 318, and a storage adapter 320.

The interconnect 310 may interconnect various subsystems, elements, and/or components of the external system 300. As shown, the interconnect 310 may be an abstraction that may represent any one or more separate physical buses, point-to-point connections, or both, connected by appropriate bridges, adapters, or controllers. In some examples, the interconnect 310 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1394 bus, or “firewire,” or other similar interconnection element.

In some examples, the interconnect 310 may allow data communication between the processor 312 and system memory 318, which may include read-only memory (ROM) or flash memory (neither shown), and random access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 312 may be the central processing unit (CPU) of the computing device and may control overall operation of the computing device. In some examples, the processor 312 may accomplish this by executing software or firmware stored in system memory 318 or other data via the storage adapter 320. The processor 312 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 314 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 316 may provide the computing device with an ability to communicate with a variety of remote devices over a network (e.g., network 400 of FIG. 1A) and may include, for example, an Ethernet adapter, a Fibre Channel adapter, and/or other wired- or wireless-enabled adapter. The network interface 316 may provide a direct or indirect connection from one network element to another, and facilitate communication and between various network elements.

The storage adapter 320 may connect to a standard computer-readable medium for storage and/or retrieval of information, such as a fixed disk drive (internal or external).

Many other devices, components, elements, or subsystems (not shown) may be connected in a similar manner to the interconnect 310 or via a network (e.g., network 400 of FIG. 1A). Conversely, all of the devices shown in FIG. 3 need not be present to practice the present disclosure. The devices and subsystems can be interconnected in different ways from that shown in FIG. 3. Code to implement the dynamic approaches for payment gateway selection and payment transaction processing of the present disclosure may be stored in computer-readable storage media such as one or more of system memory 318 or other storage. Code to implement the dynamic approaches for payment gateway selection and payment transaction processing of the present disclosure may also be received via one or more interfaces and stored in memory. The operating system provided on system 100 may be MS-DOS, MS-WINDOWS, OS/2, OS X, IOS, ANDROID, UNIX, Linux, or another operating system.

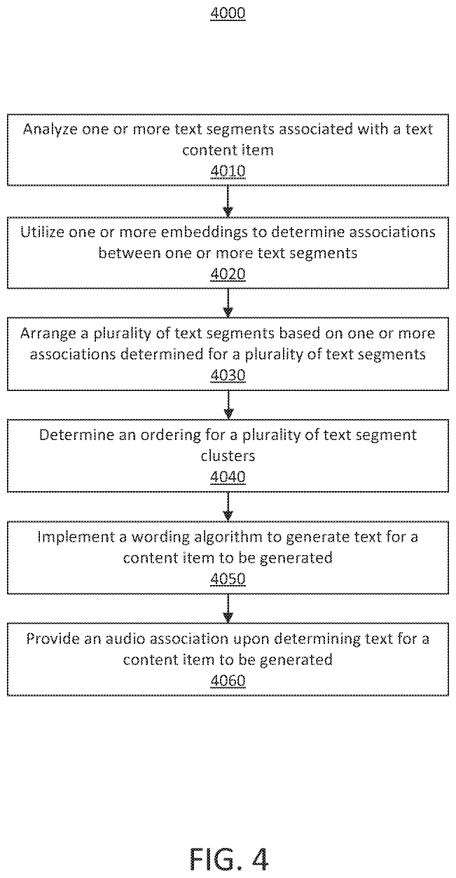

FIG. 4 illustrate a method for using artificial intelligence (AI) techniques to generate audio and video content based on text content. The method 4000 is provided by way of example, as there may be a variety of ways to carry out the method described herein. Each block shown in FIG. 4 may further represent one or more processes, methods, or subroutines, and one or more of the blocks may include machine-readable instructions stored on a non-transitory computer-readable medium and executed by a processor or other type of processing circuit to perform one or more operations described herein.

Although the method 4000 is primarily described as being performed by system 100 as shown in FIGS. 2A-B, the method 4000 may be executed or otherwise performed by other systems, or a combination of systems. It should be appreciated that, in some examples, to generate audio and video content based on text content, the method 4000 may be configured to incorporate artificial intelligence (AI) or deep learning techniques, as described above. It should also be appreciated that, in some examples, the method 4000 may be implemented in conjunction with a content platform (e.g., a social media platform) to generate and deliver content.

Reference is now made with respect to FIG. 4. At 4010, the processor 101 may analyze one or more text segments associated with a text content item. In particular, in some examples, the processor 101 may analyze text associated with a text segment (e.g., a question and an associated answer) to generate an embedding. In some examples, the processor 101 may generate the embedding having one dimension associated with content of a text segment and having another dimension associated with a user that may have originated a text segment. It should be appreciated that to generate an embedding, the processor 101 may implement a neural network (NN), such as Word2Vec, to determine one or more word associations present in a text segment.

At 4020, the processor 101 may utilize one or more embeddings to determine associations between one or more text segments. In particular, in some examples, the processor 101 may determine associations between a plurality of text segments based on content (i.e., subject matter). For example, in some instances, the processor 101 may determine a second “follow-up” text segment may be related to a first “originating” text segment.

At 4030, the processor 101 may arrange a plurality of text segments based on one or more associations determined for the plurality of text segments. In particular, in some examples, the processor 101 may “cluster” a plurality of text segments based on various criteria and/or associations. In some examples, the processor 101 may implement various algorithms to arrange the one or more text segments, including K-means clustering, hierarchical clustering or CURE (clustering using representatives).

At 4040, the processor 101 may determine an ordering for a plurality of text segment clusters. So, in some examples, text segments with a greater positive feedback may be ordered before questions with lesser feedback. Also, in some examples, the ordering may be implemented to provide a “natural” and/or “conversational” quality. To implement an ordering for the plurality of text segment clusters, the processor 101 may, in some examples, utilize an ordering score that may be assigned to each text segment cluster based on an ordering criteria.

At 4050, the processor 101 may implement a wording algorithm to generate text for a content item to be generated. Also, in some examples, a series of words of a text segment may be associated with corresponding text, wherein the series of words of the text segment and the corresponding text may constitute a “pair”. In some examples, and a neural network (e.g., a recurrent neural network (RNN)) may utilize these “pairs” to generate the text for the content item. In some examples, the processor 101 may utilize and/or implement a recurrent neural network (RNN) to associate text of a text segment from an ordered cluster of text segments to (corresponding) text for a content item to be generated. In addition, in some examples, the processor 101 may implement an interest score associated with the user to generate the text for the content item as well.

At 4060, In some examples, upon determining text for a content item to be generated, the processor 101 may provide an audio association. In particular, in some examples, the processor 101 may provide a “vocalization” of the text for the content item to be generated. In particular, in some examples, the processor 101 may enable audience members to indicate a preference associated with a vocalization. In some instances, where an audience member may not have provided a preference, the processor 101 may utilize a generic voice to generate the audio association as well.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

It should be noted that the functionality described herein may be subject to one or more privacy policies, described below, enforced by the system 100, the external system 200, and the user devices 300A-B that may bar use of images for concept detection, recommendation, generation, and analysis.

In particular examples, one or more objects of a computing system may be associated with one or more privacy settings. The one or more objects may be stored on or otherwise associated with any suitable computing system or application, such as, for example, the system 100, the external system 200, and the user devices 300, a social-networking application, a messaging application, a photo-sharing application, or any other suitable computing system or application. Although the examples discussed herein may be in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” of users or other entities that should not be allowed to access certain information associated with the object. In particular examples, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the system 100, the external system 200, and the user devices 300, or shared with other systems. Although this disclosure describes using particular privacy settings in a particular manner, this disclosure contemplates using any suitable privacy settings in any suitable manner.

In particular examples, the system 100, the external system 200, and the user devices 300A-B may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the system 100, the external system 200, and the user devices 300A-B may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular examples, different privacy settings may be provided for different user groups or user demographics.

In particular examples, the system 100, the external system 200, and the user devices 300A-B may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular examples, privacy settings may allow a first user to specify (e.g., by opting out, by not opting in) whether the system 100, the external system 200, and the user devices 300A-B may receive, collect, log, or store particular objects or information associated with the user for any purpose. In particular examples, privacy settings may allow the first user to specify whether particular applications or processes may access, store, or use particular objects or information associated with the user. The privacy settings may allow the first user to opt in or opt out of having objects or information accessed, stored, or used by specific applications or processes. The system 100, the external system 200, and the user devices 300A-B may access such information in order to provide a particular function or service to the first user, without the system 100, the external system 200, and the user devices 300A-B having access to that information for any other purposes. Before accessing, storing, or using such objects or information, the system 100, the external system 200, and the user devices 300A-B may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the system 100, the external system 200, and the user devices 300.

In particular examples, a user may specify whether particular types of objects or information associated with the first user may be accessed, stored, or used by the system 100, the external system 200, and the user devices 300. As an example and not by way of limitation, the first user may specify that images sent by the first user through the system 100, the external system 200, and the user devices 300A-B may not be stored by the system 100, the external system 200, and the user devices 300. As another example and not by way of limitation, a first user may specify that messages sent from the first user to a particular second user may not be stored by the system 100, the external system 200, and the user devices 300. As yet another example and not by way of limitation, a first user may specify that all objects sent via a particular application may be saved by the system 100, the external system 200, and the user devices 300.

In particular examples, privacy settings may allow a first user to specify whether particular objects or information associated with the first user may be accessed from the system 100, the external system 200, and the user devices 300. The privacy settings may allow the first user to opt in or opt out of having objects or information accessed from a particular device (e.g., the phone book on a user's smart phone), from a particular application (e.g., a messaging app), or from a particular system (e.g., an email server). The system 100, the external system 200, and the user devices 300A-B may provide default privacy settings with respect to each device, system, or application, and/or the first user may be prompted to specify a particular privacy setting for each context. As an example and not by way of limitation, the first user may utilize a location-services feature of the system 100, the external system 200, and the user devices 300A-B to provide recommendations for restaurants or other places in proximity to the user. The first user's default privacy settings may specify that the system 100, the external system 200, and the user devices 300A-B may use location information provided from one of the user devices 300A-B of the first user to provide the location-based services, but that the system 100, the external system 200, and the user devices 300A-B may not store the location information of the first user or provide it to any external system. The first user may then update the privacy settings to allow location information to be used by a third-party image-sharing application in order to geo-tag photos.

In particular examples, privacy settings may allow a user to specify whether current, past, or projected mood, emotion, or sentiment information associated with the user may be determined, and whether particular applications or processes may access, store, or use such information. The privacy settings may allow users to opt in or opt out of having mood, emotion, or sentiment information accessed, stored, or used by specific applications or processes. The system 100, the external system 200, and the user devices 300A-B may predict or determine a mood, emotion, or sentiment associated with a user based on, for example, inputs provided by the user and interactions with particular objects, such as pages or content viewed by the user, posts or other content uploaded by the user, and interactions with other content of the online social network. In particular examples, the system 100, the external system 200, and the user devices 300A-B may use a user's previous activities and calculated moods, emotions, or sentiments to determine a present mood, emotion, or sentiment. A user who wishes to enable this functionality may indicate in their privacy settings that they opt in to the system 100, the external system 200, and the user devices 300A-B receiving the inputs necessary to determine the mood, emotion, or sentiment. As an example and not by way of limitation, the system 100, the external system 200, and the user devices 300A-B may determine that a default privacy setting is to not receive any information necessary for determining mood, emotion, or sentiment until there is an express indication from a user that the system 100, the external system 200, and the user devices 300A-B may do so. By contrast, if a user does not opt in to the system 100, the external system 200, and the user devices 300A-B receiving these inputs (or affirmatively opts out of the system 100, the external system 200, and the user devices 300A-B receiving these inputs), the system 100, the external system 200, and the user devices 300A-B may be prevented from receiving, collecting, logging, or storing these inputs or any information associated with these inputs. In particular examples, the system 100, the external system 200, and the user devices 300A-B may use the predicted mood, emotion, or sentiment to provide recommendations or advertisements to the user. In particular examples, if a user desires to make use of this function for specific purposes or applications, additional privacy settings may be specified by the user to opt in to using the mood, emotion, or sentiment information for the specific purposes or applications. As an example and not by way of limitation, the system 100, the external system 200, and the user devices 300A-B may use the user's mood, emotion, or sentiment to provide newsfeed items, pages, friends, or advertisements to a user. The user may specify in their privacy settings that the system 100, the external system 200, and the user devices 300A-B may determine the user's mood, emotion, or sentiment. The user may then be asked to provide additional privacy settings to indicate the purposes for which the user's mood, emotion, or sentiment may be used. The user may indicate that the system 100, the external system 200, and the user devices 300A-B may use his or her mood, emotion, or sentiment to provide newsfeed content and recommend pages, but not for recommending friends or advertisements. The system 100, the external system 200, and the user devices 300A-B may then only provide newsfeed content or pages based on user mood, emotion, or sentiment, and may not use that information for any other purpose, even if not expressly prohibited by the privacy settings.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example and not by way of limitation, a user may specify that a particular image uploaded by the user is visible to the user's friends for the next week, after which time the image may no longer be accessible to other users. As another example and not by way of limitation, a company may post content related to a product release ahead of the official launch, and specify that the content may not be visible to other users until after the product launch.

In particular examples, for particular objects or information having privacy settings specifying that they are ephemeral, the system 100, the external system 200, and the user devices 300A-B may be restricted in its access, storage, or use of the objects or information. The system 100, the external system 200, and the user devices 300A-B may temporarily access, store, or use these particular objects or information in order to facilitate particular actions of a user associated with the objects or information, and may subsequently delete the objects or information, as specified by the respective privacy settings. As an example and not by way of limitation, a first user may transmit a message to a second user, and the system 100, the external system 200, and the user devices 300A-B may temporarily store the message in a content data store until the second user has viewed or downloaded the message, at which point the system 100, the external system 200, and the user devices 300A-B may delete the message from the data store. As another example and not by way of limitation, continuing with the prior example, the message may be stored for a specified period of time (e.g., 2 weeks), after which point the system 100, the external system 200, and the user devices 300A-B may delete the message from the content data store.

In particular examples, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular examples, the system 100, the external system 200, and the user devices 300A-B may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the system 100, the external system 200, and the user devices 300. The user's privacy settings may specify that such information may be used only for particular processes, such as authentication, and further specify that such information may not be shared with any external system or used for other processes or applications associated with the system 100, the external system 200, and the user devices 300. As another example and not by way of limitation, the system 100, the external system 200, and the user devices 300A-B may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any external system or used by other processes or applications associated with the system 100, the external system 200, and the user devices 300. As another example and not by way of limitation, the system 100, the external system 200, and the user devices 300A-B may provide a functionality for a user to provide a reference image (e.g., a facial profile, a retinal scan) to the online social network. The online social network may compare the reference image against a later-received image input (e.g., to authenticate the user, to tag the user in photos). The user's privacy setting may specify that such voice recording may be used only for a limited purpose (e.g., authentication, tagging the user in photos), and further specify that such voice recording may not be shared with any external system or used by other processes or applications associated with the system 100, the external system 200, and the user devices 300.

In particular examples, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The system 100, the external system 200, and the user devices 300A-B may determine that this privacy setting also applies to the first image and make the first image visible only to the first user group. In particular examples, the change in privacy settings may take effect only going forward. Continuing the example above, if the first user changes privacy settings and then shares a second image, the second image may be visible only to the first user group, but the first image may remain visible to all users. In particular examples, in response to a user action to change a privacy setting, the system 100, the external system 200, and the user devices 300A-B may further prompt the user to indicate whether the user wants to apply the changes to the privacy setting retroactively. In particular examples, a user change to privacy settings may be a one-off change specific to one object. In particular examples, a user change to privacy may be a global change for all objects associated with the user.

In particular examples, the system 100, the external system 200, and the user devices 300A-B may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular examples, upon determining that a trigger action has occurred, the system 100, the external system 200, and the user devices 300A-B may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (e.g., “public”). However, if the user changes his or her relationship status, the system 100, the external system 200, and the user devices 300A-B may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the system 100, the external system 200, and the user devices 300A-B may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example and not by way of limitation, the system 100, the external system 200, and the user devices 300A-B may send a reminder to the user to confirm his or her privacy settings every six months or after every ten photo posts. In particular examples, privacy settings may also allow users to control access to the objects or information on a per-request basis. As an example and not by way of limitation, the system 100, the external system 200, and the user devices 300A-B may notify the user whenever an external system attempts to access information associated with the user, and require the user to provide verification that access should be allowed before proceeding.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

1. A system, comprising:
a processor;
a memory storing instructions, which when executed by the processor, cause the processor to:
analyze a plurality of text segments associated with a text content item having text content;
determine an association between the plurality of text segments;
arrange the plurality of text segments based on the determined association, wherein the arranging includes generating one or more text segment clusters;
order the one or more text segment clusters according to one or more ordering criteria;
implement a wording algorithm to generate text for a content item to be generated based on the text content; and
generate an audio association for the text for the content item to be generated.

2. The system of claim 1, wherein to analyze the plurality of text segments, the instructions cause the processor to generate an embedding associated with one or more of the plurality of text segments.

3. The system of claim 2, wherein the embedding includes a dimension associated with content of the plurality of text segments.

4. The system of claim 2, wherein the embedding includes a dimension associated with where a text segment falls in a sequence of the plurality of text segments.

5. A method for generating audio and video content based on text content, comprising:
analyzing a plurality of text segments associated with a text content item;
determining an association between the plurality of text segments;
arranging the plurality of text segments based on the determined association, wherein the arranging includes generating one or more text segment clusters;
ordering the one or more text segment clusters according to one or more ordering criteria;
implementing a wording algorithm to generate text for a content item to be generated; and
generating an audio association for the text for the content item to be generated.

6. The method of claim 5, wherein analyzing the plurality of text segments includes generating an embedding, and wherein the embedding includes a dimension associated with a predicted interest level of an audience member.

7. The method of claim 5, wherein determining the association includes determining a relationship between the plurality of text segments.

8. The method of claim 5, wherein determining the association includes identifying and analyzing key words from the plurality of text segments to determine a topic.

9. The method of claim 5, wherein determining the association includes identifying a redundancy and generating a text summary to reduce redundant subject matter.

10. The method of claim 5, wherein generating one or more text segment clusters includes clustering a first text segment of the plurality of text segments with a plurality of other text segments of the plurality of text segments.

11. The method of claim 5, wherein the one or more ordering criteria includes qualitative criteria for providing a particular experience to an audience member.

12. The method of claim 5, wherein ordering the one or more text segment clusters includes utilizing aspects associated with an audience member.

13. A non-transitory computer-readable storage medium having an executable stored thereon, which when executed instructs a processor to:
analyze a plurality of text segments associated with a text content item;
determine an association between the plurality of text segments;
order the one or more text segment clusters according to one or more ordering criteria;
implement a wording algorithm to generate text for a content item to be generated; and
generate an audio association for the text for the content item to be generated.

14. The non-transitory computer-readable storage medium of claim 13, wherein ordering the one or more text segment clusters includes utilizing aspects associated with an audience member.

15. The non-transitory computer-readable storage medium of claim 14, wherein the aspects associated with the audience member includes preference information for the audience member.

16. The non-transitory computer readable storage medium of claim 15, wherein the preference information for the audience member is generated by a recommendation algorithm associated with the audience member.

17. The non-transitory computer-readable storage medium of claim 13, wherein implementing the wording algorithm includes associating text from a text segment of the plurality of text segments with corresponding text.

18. The non-transitory computer-readable storage medium of claim 13, the audio association is generated according to a preferred vocalization.

19. The non-transitory computer-readable storage medium of claim 13, wherein analyzing the plurality of text segments includes generating an embedding associated with one or more of the plurality of text segments.

20. The non-transitory computer-readable storage medium of claim 19, wherein the embedding includes a dimension based on a determination of where a text segment of the plurality of text segments falls in a sequence of the plurality of text segments.
